(19) United States
(12) Patent Application Publication
(10) Pub. No.: US 2026/0016849 A1
(43) Pub. Date: Jan. 15, 2026

(54) ADJUSTABLE MECHANICAL MOTION RANGE LIMITATION APPARATUS

(71) Applicant: FORCE DIMENSION, Nyon (CH)

(72) Inventors: François Conti, Aubonne (CH); Sébastien Grange, Lausanne (CH); Patrick Helmer, Bernex (CH); Patrice Rouiller, Trélex (CH)

(21) Appl. No.: 19/112,228

(22) PCT Filed: Sep. 16, 2022
(86) PCT No.: PCT/EP2022/075740

§ 371 Date: Mar. 14, 2025

(51) Int. Cl. G05G 5/04; G05G 5/03; G05G 9/047

(52) U.S. Cl. CPC G05G 5/04; G05G 5/03; G05G 9/047; G05G 2505/00

(57) ABSTRACT

The present disclosure relates to an adjustable mechanical motion range limitation apparatus being configured for arrangement between a pair of linkage members of a haptic device and comprising a mechanical motion limitation device being moveable, independently from the active feedback device, in relation to the first linkage members, and having, in relation to the first linkage member, a lock position in which the first mechanical motion limitation device limits, by mechanical contact, an available motion range between the first linkage member and the second linkage member.

### FIELD OF THE INVENTION

The present invention generally relates to haptic devices and, particularly, to mechanical apparatus for limiting motion ranges between movable linkage members of haptic devices.

### BACKGROUND

Haptic devices comprise, generally, a moveable user interface member, actuators, and mechanical linkage members to provide force and/or torque feedback to the user. Mechanical motion range limits between moveable linkage members generally constrain the workspace that can be reached when moving the user interface member. These motion limits or end-stops occur at fixed locations between moveable linkage members and usually ensure that individual joints, kinematics chains, transmission means, actuators, sensors and/or electrical cables operate within their admissible motion ranges.

### SUMMARY OF THE INVENTION

The present disclosure relates to mechanical apparatus for limiting motion ranges between movable linkage members of haptic devices.

Generally, the present disclosure relates to an adjustable mechanical motion range limitation apparatus being configured for arrangement between a pair of linkage members of a haptic device and comprising a mechanical motion limitation device being moveable, independently from the active feedback device, in relation to the first linkage member FLM, and having, in relation to the first linkage member FLM, a lock position in which the first mechanical motion limitation device FMMLD limits, by mechanical contact, an available motion range between the first linkage member FLM and the second linkage member SLM.

In some aspects, the present disclosure relates to an adjustable mechanical motion range limitation apparatus for mechanically limiting relative motion between a pair of linkage members of a haptic device, wherein the haptic device includes
an active feedback device for providing active force and/or torque feedback towards a user of the haptic device,
a moveable user interface member,
wherein the pair of linkage members comprises a first linkage member and a second linkage member being movable in relation to each other,
wherein a motion range of the pair of linkage members controls a motion range of the moveable user interface member, the adjustable mechanical motion range limitation apparatus comprising
a first mechanical motion limitation device being moveable, independently from the active feedback device, in relation to the first linkage member, and
a second mechanical motion limitation device being coupled to the second linkage member, wherein the first mechanical motion limitation device has, in relation to the first linkage member, a lock position in which the first mechanical motion limitation device mechanically engages with the with the second mechanical motion limitation device, thereby at least limiting a motion range between the first linkage member and the second linkage member.

The second mechanical motion limitation device may be provided at a fixed location with respect to the second linkage member.

The second mechanical motion limitation device may be is movable with respect to the second linkage member.

The first mechanical motion limitation device may be coupled with the first linkage member by at least one of the following:
revolute joint,
prismatic joint,
cardan joint,
universal joint,
spherical joint,
cylindrical joint,
screw joint,
planar joint,
elastically deformable joint,
hinge,
flexible beam,
a guide for linear movement of the first mechanical motion limitation device.

The adjustable mechanical motion range limitation apparatus may comprise a passive energy storing-releasing device being configured to provide force and/or torque to the first mechanical motion limitation device.

The passive energy storing-releasing device may comprise at least one of the following:
material being elastically deformable,
spring,
flexible beam,
magnet,
moveable mass.

The adjustable mechanical motion range limitation apparatus may comprised a controllable active actuator, which is associated to at least one of the first linkage member and the second linkage member.

The controllable active actuator may be adapted to provide force and/or torque to the first mechanical motion limitation device.

The controllable active actuator may comprise at least one of the following:
electromagnetic motor,
voice-coil actuator,
moving-magnet actuator,
permanent magnet,
monostable solenoid,
bistable solenoid,
pneumatic actuator,
piezoelectric actuator,
hydraulic actuator.

The adjustable mechanical motion range limitation apparatus may comprise an actuator controller.

The actuator controller may be configured to control the position and/or the movement and/or the velocity and/or the acceleration and/or the force and/or the torque of the controllable active actuator.

The actuator controller may be configured to control the position and/or the movement and/or the velocity and/or the acceleration and/or the force and/or the torque of the actuator in dependence of a relative position and/or movement and/or velocity and/or force and/or torque between the first linkage member and second linkage member.

The actuator controller may comprise at least one of the following:
switch,
user interface,
computer,
joystick or joypad,
touch screen,
closed-loop feedback.

The adjustable mechanical motion range limitation apparatus may comprise a sensor device being configured to detect position and/or movement and/or force and/or torque of the first mechanical motion limitation device.

The sensor device may comprise at least one of the following:
electrical contact,
electrical and/or mechanical switch,
position encoder,
linear encoder,
rotational encoder,
potentiometer,
capacitive sensor,
inductive sensor,
piezoelectric sensor,
optical sensor,
Hall-effect sensor,
magnetic sensor,
accelerometer,
inclinometer,
strain gage.

The adjustable mechanical motion range limitation apparatus may comprise a control member being configured to manually, by a user, to at least one of
position the first mechanical motion limitation device,
move the first mechanical motion limitation device,
apply a force on the first mechanical motion limitation device,
apply a torque on the first mechanical motion limitation device.

The control member may comprise at least one of the following:
button,
slider,
knob,
ring,
lever,
pull tab.

The adjustable mechanical motion range limitation apparatus according to one of the preceding claims, further comprising a damping device coupled to at least one of the first mechanical motion limitation device and the second mechanical motion limitation device, wherein the damping device is configured to damp at least one of a force and/or a torque acting on at least one of the first mechanical motion limitation device and the second mechanical motion limitation device upon engagement of the first mechanical motion limitation device and the second mechanical motion limitation device.

The damping device may comprise at least one of the following:
spring,
elastically deformable material,
flexible beam,
visco-elastic material,
rubber,
viscous fluid,
electrorheological fluid,
magnetorheological fluid,
lever,
magnet,
piston.

The adjustable mechanical motion range limitation apparatus may comprise a transmission mechanism being coupled with the first mechanical motion limitation device.

The transmission mechanism may be configured to couple the first mechanical motion limitation device and at least one of the passive energy storing-releasing device, the controllable active actuator and the control member.

The transmission mechanism may comprise at least one of the following:
lead screw,
screw-nut arrangement,
bar linkage arrangement,
lever,
crank mechanism,
slider mechanism,
motion link,
yoke mechanism,
gears,
epicyclic gear train,
strain wave drive,
cycloidal drive,
rack and pinion arrangement,
cable drive,
belt drive,
cam.

The first mechanical motion limitation device may comprise at least one of the following:
pin,
bolt,
lever,
slider,
ratchet,
eccentric wheel,
protrusion,
depression,
wedge,
disc,
ring,
screw,
screw-nut mechanism,
crank mechanism,
slider mechanism,
motion link,
yoke mechanism,
gear,
cam.

The second mechanical motion limitation device may comprise at least one of the following:
hole in the second linkage member,
opening in the second linkage member,
protrusion,
depression,
teeth,
pin,
wedge,
bolt,
lever,
slider,
ratchet,
eccentric wheel,
disc,
ring,
screw,
screw-nut mechanism,
crank mechanism,
slider mechanism,
motion link,
yoke mechanism,
gear,
cam.

The adjustable mechanical motion range limitation apparatus may comprise at least one of
at least one further first mechanical motion limitation device, and
at least one further second mechanical motion limitation device.

The adjustable mechanical motion range limitation apparatus may be adapted to limit the motion range between the first linkage member and the second linkage member in such a manner that the relative motion between the first linkage member and the second linkage member is constrained and/or locked in place when the first mechanical motion limitation devices and the second mechanical motion limitation device engage.

In further aspects, the present disclosure relates to an haptic device comprising
a pair of linkage members,
an active feedback device for providing active force and/or torque feedback towards a user of the haptic device,
a moveable user interface member, wherein
the pair of linkage members comprises a first linkage member and a second linkage member being movable in relation to each other,
a motion range of the pair of linkage members controls a motion range of the moveable user interface member,

The haptic device may further comprise an adjustable mechanical motion range limitation apparatus in line with the respective preceding disclosure.

The haptic device may comprise at least one of the following:
pure translational base structure,
parallel kinematics translational base structure,
rotational wrist mechanism,
grasping mechanism,
hand detection sensor.

The haptic device may be comprised by at least one of the following:
operator console for single or dual hand operation,
teleoperation system wherein the haptic device is configured for remotely operating a virtual or real robotic equipment,
medical device,
surgical device,
simulation device,
training device,
rehabilitation device.

In the haptic device, at least one of the at least one adjustable mechanical motion range limitation apparatus according in line with above disclosure is adapted to constrain and/or lock at least one translational motion and/or at least one rotational motion of the moveable user interface member.

The haptic device may comprise a watch interaction simulator or is part of a watch interaction simulator.

### SHORT DESCRIPTION OF THE DRAWINGS

Examples of the present disclosure will now be described, by way of example, and with reference to the accompanying drawings, in which:

FIGS. 1A-F schematically illustrate an example of an adjustable mechanical motion range limitation apparatus,

FIG. 2 schematically illustrates an example of an adjustable mechanical motion range limitation apparatus comprising a damping device,

FIG. 3 schematically illustrates a further example of an adjustable mechanical motion range limitation apparatus comprising a damping device,

FIG. 4 schematically illustrates an example of an adjustable mechanical motion range limitation apparatus comprising an energy storing-releasing device,

FIG. 5 schematically illustrates further examples of energy storing-releasing devices,

FIG. 6 schematically illustrates an example of an adjustable mechanical motion range limitation apparatus comprising an actuator for positioning a mechanical motion limitation device,

FIG. 7 schematically illustrates a further example of an adjustable mechanical motion range limitation apparatus comprising an actuator for positioning a mechanical motion limitation device,

FIG. 8 schematically illustrates an example of an adjustable mechanical motion range limitation apparatus comprising position sensor devices,

FIG. 9 schematically illustrates an example of an adjustable mechanical motion range limitation apparatus providing progressive motion limitation characteristics,

FIG. 10 schematically illustrates further examples of adjustable mechanical motion range limitation apparatus providing progressive motion limitation characteristics,

FIG. 11 schematically illustrates an example of an adjustable mechanical motion range limitation apparatus comprising a mechanical motion limitation device providing park/block characteristics,

FIG. 12 schematically illustrates an example of an adjustable mechanical motion range limitation apparatus comprising a rotatable mechanical motion limitation device,

FIG. 13 schematically illustrates an example of an adjustable mechanical motion range limitation apparatus comprising a mechanical motion limitation device for limiting rotational motion of a first linkage member and the second linkage member in relation to each other,

FIG. 14 schematically illustrates an example of an adjustable mechanical motion range limitation apparatus comprising indirectly coupled first and second linkage members,

FIGS. 15A-B schematically illustrates an example of an adjustable mechanical motion range limitation apparatus comprising a mechanical motion limitation device for limiting more than one degree of freedom between a first linkage member and a second linkage member,

FIG. 16 schematically illustrates an example of a haptic device having a pair of linkage members having mechanical motion limitation devices,

FIGS. 17A-B schematically illustrate a first linkage member and a second linkage member of FIG. 16 coupled with a first mechanical motion limitation device and to a second mechanical motion limitation device, respectively,

FIG. 18 schematically illustrates a further example of an adjustable mechanical motion range limitation apparatus, e.g., for a haptic interaction simulation device,

FIG. 19 schematically illustrates a further example of an adjustable mechanical motion range limitation apparatus, e.g., for a haptic device wrist mechanism.

Reference numerals are not repeated in each drawing. Rather, any reference numeral shown in a drawing can be assumed to be part of any other drawing unless otherwise noted.

### DETAILED DESCRIPTION

Generally, a haptic device comprises a user interface member by means of which a user may interact with the haptic device. By manipulation of the user interface member, the user can control the haptic device. The other way round, the haptic device may provide feedback towards the user, particularly in order to provide, to the user at the user interface member, haptic sensations representing movements of and/or at the output member of the haptic device. Generally, actuators are used to provide feedback to the user.

The user interface member is generally constrained to move within a reachable workspace by fixed motion range limits between moveable members of its kinematics structure.

The relative motion between two members may be limited in a given direction. This motion limitation is referred to as an end-stop. If two moveable members are coupled by a single degree of freedom joint (e.g., revolute or prismatic joints), the motion range may be limited in each one of the two directions along this degree of freedom by an end-stop. End stops may also be implemented for higher order joints (e.g., cardan or revolute joints) or for complex joint arrangements by one or more mechanical contacts between selected moveable members or between parts mounted thereon.

Such fixed end-stops do not allow adjustment of the (relative) motion range of kinematics structures' members in relation to each other. However, it would be advantageous to be able to adjust the available motion ranges of the haptic device. The available motion range could e.g. be configured before usage, modified during usage and/or be reduced to a blocked position at the end of usage of the haptic device.

In the following, illustrative examples of possible aspects are indicated:
Prevent the user from moving a user interface member to a particular region of the workspace or “no-go” region (e.g., to prevent the teleoperated tip of a surgical instrument to cause damage to delicate tissue in a particular anatomical region, e.g., for patient safety reasons).
Avoid collisions or mechanical interference (e.g., between the two haptic devices in a bi-manual configuration).
Avoid singular configurations where the kinematics or stiffness properties degrade (e.g., in a parallel kinematics structure).
Avoid passive movements when touching the user interface member after the haptic device is turned off or when the haptic device is moved to a different location (e.g., the user interface member shall be blocked in a predefined park position before moving a haptic device on a wheeled base frame to another operating room).
Mechanical guiding constraints to the user (e.g., to assist a surgeon in performing a movement that is aligned with an anatomical feature)
Render, to the user, specific motion limitations in the execution of a given manipulation task (e.g., when a surgical instrument is inserted through a narrow opening)
Render, to the user, motion limitations that are present in a simulated or physical robotic equipment that is operated through the haptic device (e.g., the grasping degree of freedom on the haptic device would be configured to limit the same range of motion than a particular teleoperated robotic instrument)

Generally, adjustable mechanical motion range limitation apparatuses as described herein may be used for mechanically limiting relative motion between a pair of linkage members of a haptic device. It is assumed that the haptic device includes an active feedback device and a user interface member. The active feedback device may be adapted to provide active force and/or torque feedback towards a user of the haptic device. In some examples, the active feedback device is coupled to the moveable user interface member and provides the feedback, via a user interface member, to the user by applying force and/or torque to the movable user interface member. It is further assumed that the pair of linkage members comprises a first linkage member FLM and a second linkage member SLM, wherein the first linkage member FLM and the second linkage member SLM are movable in relation to each other. Moreover, it is assumed that a current motion range of the pair of linkage members controls, at least partially, a motion range of the moveable user interface member.

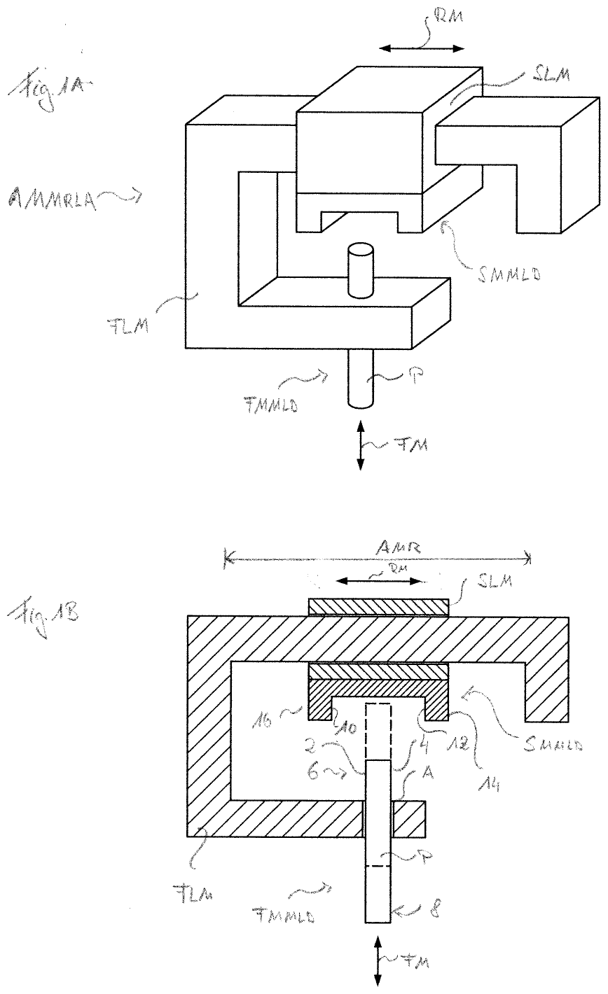

FIGS. 1A-F schematically illustrate an example of an adjustable mechanical motion range limitation apparatus AMMRLA for a pair of linkage members for/of a haptic device. The pair of linkage members comprises a first linkage member FLM and a second linkage member SLM. The first linkage member FLM and the second linkage member SLM are movable in relation to each other, as indicated by arrow RM. According to these drawings, the second linkage member SLM may be moved translationally in relation to the first linkage member FLM (or vice versa, or both linkage members may be moved simultaneously in relation to each other). An available motion range between the first linkage member FLM and the second linkage member SLM is indicated at ARM.

The adjustable mechanical motion range limitation apparatus comprises a first mechanical motion limitation device FMMLD that is movable in relation to the first linkage member FLM. The first mechanical motion limitation device FMMLD may be movable in relation to the first linkage member FLM independently from an active feedback device of a haptic device.

In the example of FIGS. 1A-F, the first mechanical motion limitation device FMMLD comprises a pin P extending through an aperture A in the first linkage member FLM. The pin P may be moved in relation to the first linkage member FLM as indicated by arrow FM. The mechanical motion limitation device has a first contact area 2 and a second contact area 4 arranged at/in an engagement portion 6 of the first mechanical motion limitation device FMMLD. In some examples, an engagement portion 6 of a mechanical motion limitation device may be considered as its part adapted for engagement with a respectively other mechanical motion limitation device.

The first mechanical motion limitation device FMMLD may further comprise an input portion 8. An input portion of a mechanical motion limitation device may be considered as its part where, for example, energy for actuating (e.g., moving, rotating) the mechanical motion limitation device may be provided to the mechanical motion limitation device. In some examples, an input portion may provide a structural feature formed at/in a mechanical motion limitation device. Such input portions may be, e.g., for inputting mechanical forces, torques, translational movement, rotational movement, etc. In some examples, an input portion may be a part of the mechanical motion limitation device where, e.g., electrical energy, magnetic energy, hydraulic energy, pneumatic energy, etc. may be input towards the mechanical motion limitation device.

The second mechanical motion limitation device SMMLD comprises a recessed shape formed for engagement with the pin P. The recessed shape may be formed into the second linkage member SLM or as separate component and attached to the second linkage member SLM. The second mechanical motion limitation device SMMLD comprises a first contact area 10 and a second contact area 12.

As illustrated in FIG. 1B, the second linkage member SLM may be moved in directions as indicated by arrow RM and the first mechanical motion limitation device FMMLD may be moved in the directions as indicated by arrow FM. This allows to limit the relative motion of the first linkage member FLM and the second linkage member SLM in relation to each other.

As illustrated in FIG. 1C, the first mechanical motion limitation device FMMLD is in a position in which the first mechanical motion limitation device FMMLD and the second motion limitation device cannot engage, also when the second linkage member SLM is moved (see arrow RM). In such a scenario, the relative motion of the first linkage member FLM and the second linkage member SLM in relation to each other is not limited by the first mechanical motion limitation device FMMLD and/or the second mechanical motion limitation device SMMLD. The position (or positions) of the first mechanical motion limitation device FMMLD in which the first mechanical motion limitation device FMMLD and the second mechanical motion limitation device SMMLD cannot engage such that a predefined (e.g., maximal possible or maximally allowed) motion range AMR between the first linkage member FLM and the second linkage member SLM is at least limited may be referred to as release position(s). The position of the first mechanical motion limitation device FMMLD shown in FIG. 1C is a release position.

As illustrated in FIG. 1D, the first mechanical motion limitation device FMMLD is in a position in which the first mechanical motion limitation device FMMLD and the second mechanical motion limitation device SMMLD may engage depending on the relative position of the first linkage member FLM and the second linkage member SLM in relation to each other. FIG. 1D illustrates a situation where the first contact area 2 of the first mechanical motion limitation device FMMLD and the first contact area 10 of the second mechanical motion limitation device SMMLD engage. This contact limits the motion range between the first linkage member FLM and the second linkage member SLM, here in that the second linkage member SLM cannot be moved further (according to the drawing) to the right.

The second linkage member SLM can be moved (according to the drawing) to the left. However, such movements are possible only until the second contact area 4 of the first mechanical motion limitation device FMMLD and the second contact area 12 of the second mechanical motion limitation device SMMLD engage. In such a situation, the contact between the first mechanical motion limitation device FMMLD and the second mechanical motion limitation device SMMLD limits the motion range between the first linkage member FLM and the second linkage member SLM, here in that the second linkage member SLM cannot be moved further (according to the drawing) to the left.

The position of the first mechanical motion limitation device FMMLD in relation to the first linkage member FLM, where the first mechanical motion limitation device FMMLD is in a position in which engagement with the second mechanical motion limitation device SMMLD is possible, is also referred to as lock position. In the lock position, the motion range between the first linkage member FLM and the second linkage member SLM is limited as indicated at LMR.

In the case the first mechanical motion limitation device FMMLD is not in the lock position, the whole motion range ARM between the first linkage member FLM and the second linkage member SLM is available.

The example of FIG. 1D illustrates a scenario where only a limited middle portion LMR of the whole available motion range AMR is available. However, relative motion between the first linkage member FLM and the second linkage member SLM is still possible.

FIGS. 1E and 1F illustrate examples where the relative motion between first linkage member FLM and the second linkage member SLM is not only limited, but blocked.

FIG. 1E illustrates a scenario, where the second linkage member SLM is confined to a position (according to the drawing) at the lefthand side of the whole available motion range AMR. To this end, the first mechanical motion limitation device FMMLD is in a lock position in which the contact area 2 of the first mechanical motion limitation device FMMLD and a contact area 14 of the second mechanical motion limitation device SMMLD contact each other.

FIG. 1F illustrates a scenario, where the second linkage member SLM is confined to a position (according to the drawing) at the righthand side of the whole available motion range AMR. To this end, the first mechanical motion limitation device FMMLD is in a lock position in which the contact area 4 of the first mechanical motion limitation device FMMLD and a contact area 16 of the second mechanical motion limitation device SMMLD contact each other.

Such scenarios may be referred to as parked position or blocked position and may be used, for example, if accidental movements of the first linkage member FLM and the second linkage member SLM in relation to each other should be avoided.

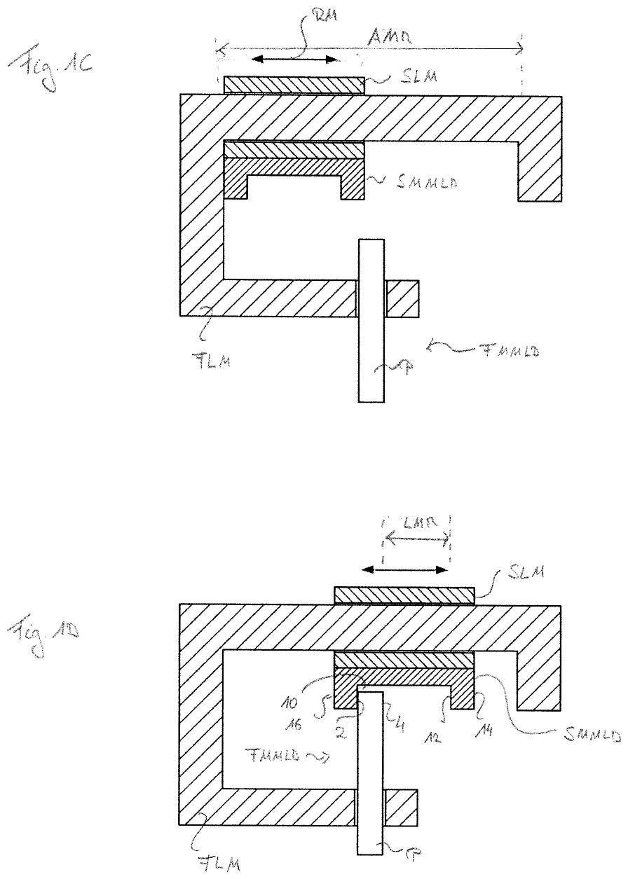

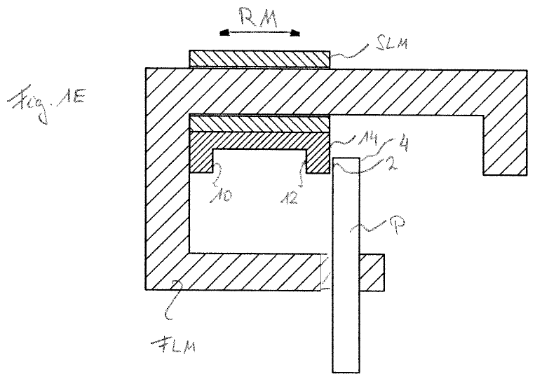

Adjustable mechanical motion range limitation apparatuses AMMRLA may include a damping device DD to damp at least one of a force and/or a torque acting on at least one of the first mechanical motion limitation device FMMLD and the second mechanical motion limitation device SMMLD upon engagement of the first mechanical motion limitation device FMMLD and the second mechanical motion limitation device SMMLD. FIGS. 2 and 3 are schematic illustrations being based on the examples of FIGS. 1A-F. However, the principles of FIGS. 2 and 3 may be applied to any adjustable mechanical motion range limitation apparatus AMMRLA in line with the present disclosure.

According to FIG. 2, a damping device DD is arranged at the second contact area 12 of the second mechanical motion limitation device SMMLD. In further examples, a damping device DD may be, alternatively or in addition, arranged at the first contact area 10 of the second mechanical motion limitation device SMMLD. The illustrated damping device DD comprises a spring SD connected to the second contact area 12 and a contact pad CD arranged at the free end of the spring SD. If, as shown, the first mechanical motion limitation device FMMLD is in a lock position, contact of the first mechanical motion limitation device FMMLD and the second mechanical motion limitation device SMMLD is possible. In the case, the second linkage member SLM is moved (according to the drawing) to the left, the second contact area 4 of the first mechanical motion limitation device FMMLD may come in to contact with the contact pad CD and, upon further movement of the second linkage member SLM in that same direction, compresses the spring SD. This results in a dampening of the motion range limitation in that the movement is not abruptly stopped upon contact of the second contact area 4 of the first mechanical motion limitation device FMMLD and the second contact area 12 of the second mechanical motion limitation device SMMLD.

According to FIG. 3, a damping device DD is arranged at the second contact area 4 of the first mechanical motion limitation device FMMLD. In further examples, a damping device DD may be, alternatively or in addition, arranged at the first contact area 2 of the first mechanical motion limitation device FMMLD. The illustrated damping device DD comprises a spring SD connected to the second contact area 4 of the first mechanical motion limitation device FMMLD and a contact pad CD arranged at the free end of the spring SD. If, as shown, the first mechanical motion limitation device FMMLD is in its lock position, contact of the first mechanical motion limitation device FMMLD and the second motion limitation device is possible. In the case, the second linkage member SLM is moved (according to the drawing) to the left, the second contact area 12 of the second mechanical motion limitation device SMMLD may come in to contact with the contact pad CP and, and upon further movement of the second linkage member SLM in that same direction, compresses the spring SD. This results in a dampening of the motion range limitation in that the movement is not abruptly stopped upon contact of the second contact area 4 of the first mechanical motion limitation device FMMLD and the second contact area 12 of the second mechanical motion limitation device SMMLD.

In further examples, the examples of the FIGS. 2 and 3 may be combined.

The function of the spring SD in FIGS. 2 and 3 may be provided by an elastic or viscoelastic material of at least part of at least one of the first mechanical motion limitation device FMMLD, the second mechanical motion limitation device SMMLD and the contact pad CD.

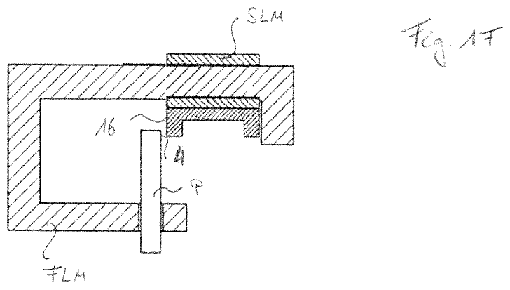

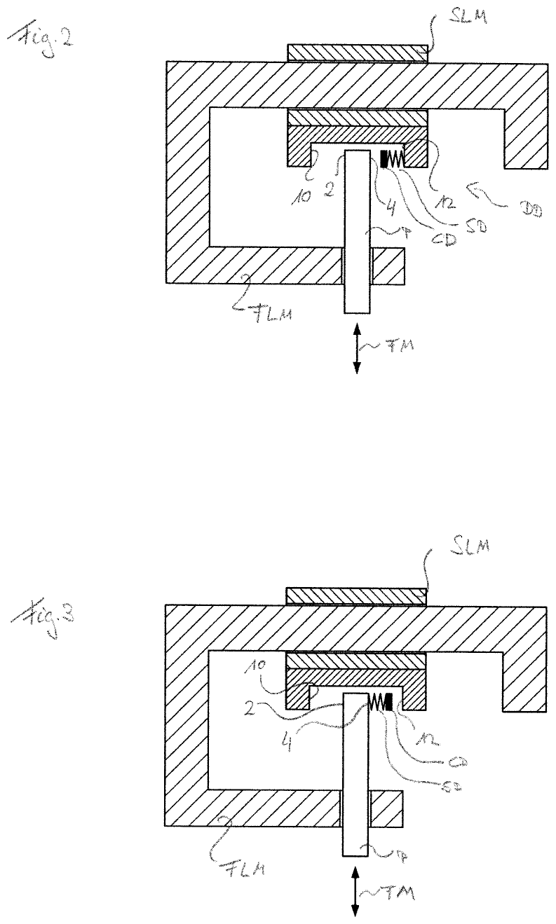

Adjustable mechanical motion range limitation apparatuses AMMRLA may include an energy storing-releasing device. Illustrative examples of an energy storing-releasing device include material being elastically deformable, spring, flexible beam, magnet, moveable mass. A passive energy storing-releasing device may be configured to provide force and/or torque to the first mechanical motion limitation device FMMLD. FIGS. 4 and 5 are schematic illustrations being based on the examples of FIGS. 1A-F. However, the principles of FIG. 4 and/or FIG. 5 may be applied to any adjustable mechanical motion range limitation apparatus AMMRLA in line with the present disclosure.

As illustrated in FIG. 4, at the first mechanical motion limitation device FMMLD, an energy storing-releasing device ESRD is provided. The energy storing-releasing device ESRD comprises a spring SED. According to the illustration, the first mechanical motion limitation device FMMLD extends through the spring SED of the energy storing-releasing device ESRD. In other examples, a mechanical motion limitation device and a spring (or any other example energy storing-releasing device) may be arranged in other spatial relation to each other, as long as it is possible that the energy storing-releasing device may store energy and output the stored energy, at least partially, as mechanical energy to the mechanical motion limitation device.

The stored energy may be provided from one or more sources including at least one of electric energy, magnetic energy, gravitational energy, elastic energy, kinetic energy, and thermal energy.

The outputted mechanical energy may include at least one of a force and a torque.

According to the drawing, the spring SED of the energy storing-releasing device ESRD is supported between a base BED and the first linkage member FLM. The base BED is coupled to the input portion 8 of the first mechanical motion limitation device FMMLD and provides a support face SFB on which an end of the spring SED can act. The other end of the spring is supported on the first linkage member FLM. Adjacent the engagement portion 6, the first mechanical motion limitation device FMMLD is provided with a collar COL. The collar COL may be arranged such that, in the case the first mechanical motion limitation device FMMLD is in a lock position, no contact of the collar COL and the second mechanical motion limitation device SMMLD is possible. Such examples allow a separation between the function of the collar COL and the engagement portion 6. In other examples, the collar COL may be positioned such that it also acts as engagement portion 6. The collar COL is optional and may, e.g., be used in the case the spring SED is (somehow) biased between the base BED and the first linkage member FLM. In one example (according to the drawing), the collar COL is in contact with the first linkage member FLM when the first mechanical motion limitation device FMMLD is in a release position.

FIG. 4 illustrates the first mechanical motion limitation device FMMLD in a release position. In the case a motion range between the first linkage member and second linkage member SLM is to be limited, the first mechanical motion limitation device FMMLD will be brought into a lock position, e.g., the lock position shown in FIG. 1D. Due this process, the spring will be compressed and store energy. This energy is stored in the spring as long as the first mechanical motion limitation device FMMLD is in the lock position.

In the case a motion range between the first linkage member FLM and second linkage member SLM is not to be limited (anymore), the first mechanical motion limitation device FMMLD is brought into the release position. To this end, the energy stored by the spring SED may be used, at least partially, to support such position changes. According to the illustration, the spring returning into its release (or if applicable, biased) configuration acts on the first mechanical motion limitation device FMMLD and brings it into the release position.

In a further example, the spring SED is arranged between the collar COL and the first linkage member FLM, such that the spring stores energy in the release position of the first mechanical motion limitation device FMMLD. The energy stored by the spring SED may be used, at least partially, to support a change in the position of the first mechanical motion limitation device FMMLD from the release position to bring it into the lock position, the spring SED thereby returning into its release (or if applicable, biased) configuration.

As illustrated in FIG. 5, at the left-hand side first mechanical motion limitation device FMMLD1, an energy storing-releasing device ESRD1 provided. The energy storing-releasing device comprises a spring SED. According to the illustration, spring SED is coupled between the first mechanical motion limitation device FMMLD1 and a support SUP.

In the illustrated position of the first mechanical motion limitation device FMMLD1, the first mechanical motion limitation device FMMLD1 is in a lock position. In the lock position, a contact of a contact area 2 of an engagement portion 6 of the first mechanical motion limitation device FMMLD1 and a contact area 16 of a second mechanical motion limitation device SMMLD limits a motion range between a first linkage member FLM and a second linkage member SLM.

If the first mechanical motion limitation device FMMLD1 is rotationally moved, as indicated by arrow FM1, into a position indicated by left-hand side dashed lines, the first mechanical motion limitation device FMMLD1 is in a release position. In the release position, the first mechanical motion limitation device FMMLD1 does not effect a limitation of a motion range between a first linkage member FLM and a second linkage member SLM.

The energy storing-releasing device ESRD1 at least supports maintaining the first mechanical motion limitation device FMMLD1 in the lock position and in the release position. In some examples, this can be achieved without the need of further energy input to this purpose.

During a change of the first mechanical motion limitation device FMMLD1 from a lock position into a release position (and vice versa), at the beginning, at least when the first mechanical motion limitation device FMMLD1 is in the starting position (i.e., lock or release position), the force of the spring SED has to be overcome until the first mechanical motion limitation device FMMLD1 has an approximately intermediate position between the starting position (i.e. lock or release position) and the target position (i.e. release or lock position). At or around the intermediate position, the spring SED may exert a force/torque onto the first mechanical motion limitation device FMMLD1 at least supporting moving the first mechanical motion limitation device FMMLD1 towards the target position (i.e., release or lock position).

The right-hand side first mechanical motion limitation device FMMLD2 of FIG. 5 provides an “internal” energy storing-releasing device ESRD2. There, the energy storing-releasing device is the gravitational potential of the mass of the first mechanical motion limitation device FMMLD2.

In the illustrated position of the first mechanical motion limitation device FMMLD2, the first mechanical motion limitation device FMMLD2 is in a lock position. In the lock position, a contact of a contact area 2 of an engagement portion 6 of the first mechanical motion limitation device FMMLD2 and a contact area 14 of a second mechanical motion limitation device SMMLD limits a motion range between a first linkage member FLM and a second linkage member SLM.

If the first mechanical motion limitation device FMMLD2 is moved, as indicated by arrow FM2, into a position indicated by right-hand side dashed lines, the first mechanical motion limitation device FMMLD2 is in a release position. In the release position, the first mechanical motion limitation device FMMLD2 does not effect a limitation of a motion range between a first linkage member FLM and a second linkage member SLM.

The energy storing-releasing device ESRD2 at least supports maintaining the first mechanical motion limitation device FMMLD2 in the lock position and in the release position. In some examples, this can be achieved without the need of further energy input to this purpose.

During a change of the first mechanical motion limitation device FMMLD2 from the lock position into the release position (and vice versa), at the beginning, at least when the first mechanical motion limitation device FMMLD2 is in the starting position (i.e., lock or release position), the gravity force acting on the center of mass of the first mechanical motion limitation device FMMLD2 has to be overcome until the first mechanical motion limitation device FMMLD2 has an approximately intermediate position between the starting position (i.e. lock or release position) and the target position (i.e. release or lock position). At or around the intermediate position, gravity may exert a force/torque onto the center of mass of the first mechanical motion limitation device FMMLD2 at least supporting moving the first mechanical motion limitation device FMMLD2 towards the target position (i.e., release or lock position).

Adjustable mechanical motion range limitation apparatuses AMMRLA may include a controllable active actuator. Illustrative examples of controllable active actuators include electromagnetic motor, voice-coil actuator, moving-magnet actuator, monostable solenoid, bistable solenoid, pneumatic actuator, piezoelectric actuator, hydraulic actuator.

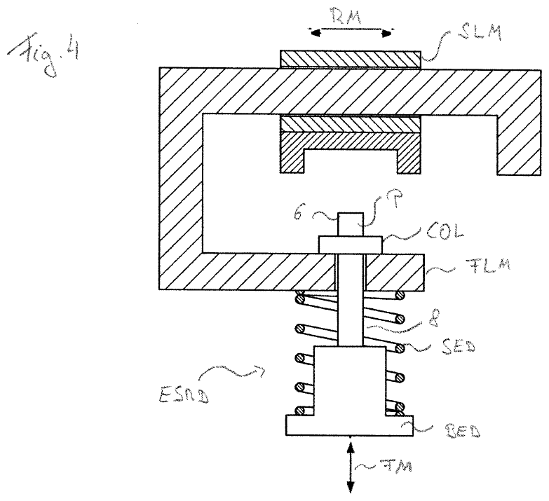

FIG. 6 is a schematic illustration being based on the examples of FIGS. 1A-F. However, the principles of FIG. 6 may be applied to any adjustable mechanical motion range limitation apparatus AMMRLA in line with the present disclosure.

FIG. 6 illustrates an example where a controllable active actuator is associated to the first linkage member FLM. According to FIG. 6, the controllable active actuator may comprise a bistable solenoid SOL being in operative engagement with the first mechanical motion limitation device FMMLD. Operative engagement particularly means here that, if the solenoid SOL is activated and is capable of providing magnetic forces and/or torques, at least one of the latter can interact with a respective mechanical motion limitation device. Particularly, such an interaction allows to move and/or position a respective mechanical motion limitation device.

According to FIG. 6, the solenoid SOL is arranged at and/or in the first linkage member FLM at a position where the first mechanical motion limitation device FMMLD extends through an aperture A in the first linkage member FLM. This allows operative engagement of the solenoid SOL and the first mechanical motion limitation device FMMLD.

The first mechanical motion limitation device FMMLD comprises a first motion range limiter limiting the motion range of the first mechanical motion limitation device FMMLD in a first direction; according to the drawing, in the downward direction. The first motion range limiter may be a collar COL. The collar COL might be similar to a collar COL for examples according to FIG. 4, or formed differently.

The first mechanical motion limitation device FMMLD may comprise a second motion range limiter limiting the motion range of the first mechanical motion limitation device FMMLD in a second direction; according to the drawing, in the upward direction. The second motion range limiter may be formed as end stop ES, and, e.g., may also act as a base like base BED of FIG. 4.

In further examples, the first motion range limiter and/or the second motion range limiter may be not used. In such examples, other measures may be used to limit the respective motion range of the first mechanical motion limitation device FMMLD.

FIG. 6 illustrates an operational state of the solenoid SOL in which the first mechanical motion limitation device FMMLD is in a release position. To this end, the solenoid SOL may be activated such that the solenoid SOL acts on the first mechanical motion limitation device FMMLD such that it is maintained in the release position. In further examples, the solenoid SOL is only partially activated, wherein a further device may be used to maintain the first mechanical motion limitation device FMMLD in a release position. For example, to this end a spring SED arranged as illustrated in FIG. 4 may be used. In a further example, to this end a permanent magnet may be arranged between the collar COL and the first linkage member FLM. In another example, to this end the direction of movement of the first mechanical motion limitation device FMMLD is such that gravity is acting on the mass of the first mechanical motion limitation device FMMLD.

In the case the motion range between the first linkage member FLM and second linkage member SLM is to be limited, the first mechanical motion limitation device FMMLD is brought into the lock position and maintained therein.

To the latter end, the solenoid SOL may be activated such that the solenoid SOL acts on the first mechanical motion limitation device FMMLD such that it is maintained in the lock position.

In further examples, the solenoid SOL is only partially activated, wherein a further device may be used to maintain the first mechanical motion limitation device FMMLD in a lock position. For example, to this end a spring SED arranged between the collar COL and the first linkage member FLM may be used.

In a further example, to this end a permanent magnet may be arranged between the end stop ES and the first linkage member FLM. In another example, to this end the direction of movement of the first mechanical motion limitation device FMMLD is such that gravity is acting on the mass of the first mechanical motion limitation device FMMLD.

In further examples, the solenoid SOL is activated just such that the solenoid SOL acts on the first mechanical motion limitation device FMMLD in a release position for moving the first mechanical motion limitation device FMMLD from a release position into the lock position. The solenoid SOL may not be permanently activated when the first mechanical motion limitation device FMMLD is in a release position.

In further examples, the solenoid SOL is activated just such that the solenoid SOL acts on the first mechanical motion limitation device FMMLD in a lock position for moving the first mechanical motion limitation device FMMLD from a lock position into a release position. The solenoid SOL may not be permanently activated when the first mechanical motion limitation device FMMLD is in a lock position.

Combinations of the two preceding examples are also covered by the present disclosure.

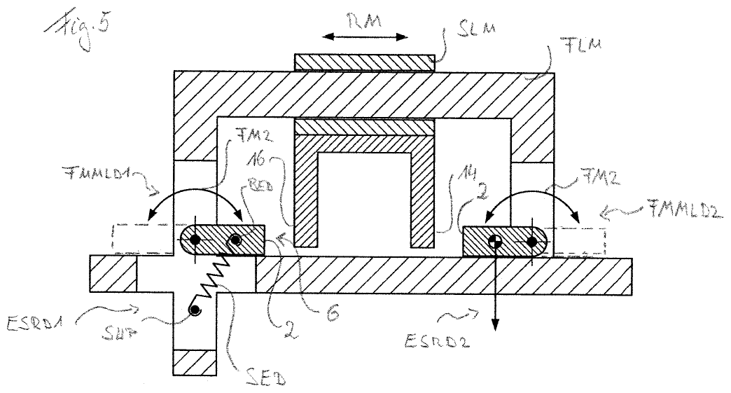

FIG. 7 illustrates an example where a controllable active actuator is associated to the first linkage member FLM. According to FIG. 7, the controllable active actuator may comprise a voice-coil actuator VCA. The voice-coil actuator VCA comprises a coil COIL and a core COR. According to the drawing, the coil COIL is coupled with the first mechanical motion limitation device FMMLD, while the core COR is provided a fixed position in relation to the first linkage member FLM. In such examples, where in addition the first mechanical motion limitation device FMMLD comprises an end stop ES, the coil COIL may be coupled to the end stop ES. In other examples, the core COR is coupled with the first mechanical motion limitation device FMMLD, while the coil COIL is provided a fixed position in relation to the first linkage member FLM.

The voice-coil actuator VCA is in operative engagement with the first mechanical motion limitation device FMMLD. Operative engagement particularly means here that, if the voice-coil actuator VCA is activated and is capable of providing magnetic forces and/or torques, at least one of the latter can interact with a respective mechanical motion limitation device. Particularly, such an interaction allows to move and/or position a respective mechanical motion limitation device.

The first mechanical motion limitation device FMMLD comprises a first motion range limiter limiting the motion range of the first mechanical motion limitation device FMMLD in a first direction; according to the drawing, in the downward direction. The first motion range limiter may be a collar COL. The collar COL might be similar to a collar COL for examples according to FIG. 4, or formed differently.

The first mechanical motion limitation device FMMLD may comprise a second motion range limiter limiting the motion range of the first mechanical motion limitation device FMMLD in a second direction; according to the drawing, in the upward direction. The second motion range limiter may be formed as end-stop ES, and, e.g., may also act as a base like base BED of FIG. 4.

In further examples, the first motion range limiter and/or the second motion range limiter may be not used. In such examples, other measures may be used to limit the respective motion range of the first mechanical motion limitation device FMMLD.

FIG. 7 illustrates an operational state of the voice-coil COIL actuator VCO in which the first mechanical motion limitation device FMMLD is in a release position. To this end, the coil COIL may be activated such that the coil COIL is maintained in its position illustrated in FIG. 7. In further examples, the voice-coil actuator VCA may be only partially maintained activated in the situation where the first mechanical motion limitation device FMMLD is in a release position, wherein a further device may be used to maintain the first mechanical motion limitation device FMMLD in the release position. For example, to this end a spring SED arranged as illustrated in FIG. 4 may be used.

In a further example, to this end a permanent magnet may be arranged between the collar COL and the first linkage member FLM. In another example, to this end the direction of movement of the first mechanical motion limitation device FMMLD is such that gravity is acting on the mass of the first mechanical motion limitation device FMMLD.

In the case the motion range between the first linkage member and second linkage member SLM is to be limited, the first mechanical motion limitation device FMMLD is brought into the lock position and maintained therein. To the latter end, the coil COIL of the voice-coil actuator may be activated such that the coil COIL is moved from its position of FIG. 7, according to the drawing, in upwards direction. This brings the first mechanical motion limitation device FMMLD in a lock position. In order to maintain the first mechanical motion limitation device FMMLD in the lock position, the coil COIL may be maintained active.

In further examples, the voice-coil actuator VCA may be only partially maintained activated in the situation where the first mechanical motion limitation device FMMLD is in a lock position, wherein a further device may be used to maintain the first mechanical motion limitation device FMMLD in the release position. For example, to this end a spring SED arranged between the collar COL and the first linkage member FLM may be used.

In a further example, to this end a permanent magnet may be arranged between the end-stop ES and the first linkage member FLM. In another example, to this end the direction of movement of the first mechanical motion limitation device FMMLD is such that gravity is acting on the mass of the first mechanical motion limitation device FMMLD.

In case of a controllable active actuator, it is contemplated to provide an actuator controller being configured to control the position and/or the movement and/or the velocity and/or the acceleration and/or the force and/or the torque of the controllable active actuator. Such a controller may be part of or comprised by an adjustable mechanical motion range limitation apparatus AMMRLA according to the present disclosure or provided as separate unit.

Adjustable mechanical motion range limitation apparatuses AMMRLA may include at least one a sensor device being configured to detect position and/or movement and/or force and/or torque of at least one of the first and mechanical motion limitation device FMMLD and the second mechanical motion limitation device SMMLD. Illustrative examples of such at least one sensor device comprises at least one of an electrical contact, electrical switch, position encoder, linear encoder, rotational encoder, potentiometer, capacitive sensor, inductive sensor, piezoelectric sensor, optical sensor, Hall-effect sensor, magnetic sensor, accelerometer, inclinometer, strain gage.

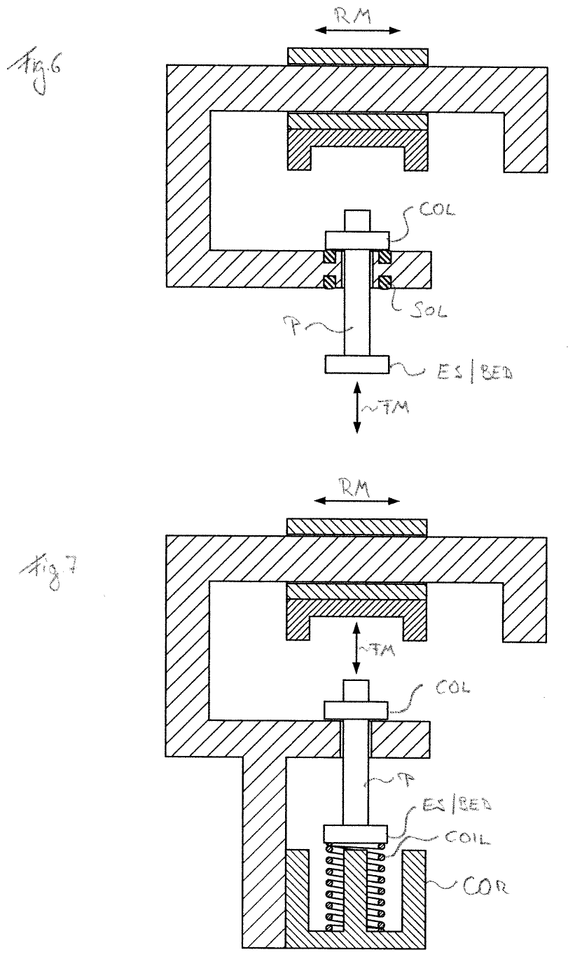

FIG. 8 is a schematic illustration being based on the examples of FIGS. 1A-F. However, the principles of FIG. 8 may be applied to any adjustable mechanical motion range limitation apparatus in line with the present disclosure.

FIG. 8 illustrates an example where two sensor devices are provided to detect the position of the first mechanical motion limitation device FMMLD. A first sensor device SD1 comprises a first switch SW1 having electrical contacts, e.g., three contacts EC1₁, EC2₁ and EC3₁ for connecting the first switch SW1 to, e.g., power supply and a switch control for operating the switch. The first switch SW1 comprises a first switch lever SWL1. By means of the first switch lever SWL1, the first switch SW1 can be turned on/off. A second sensor device SD2 comprises a second switch SW2 having electrical contacts, e.g., three contacts EC1₂, EC2₂ and EC3₂ for connecting the second switch SW2 to, e.g., power supply and a switch control for operating the switch. The second switch SW2 comprises a second switch lever SWL2. By means of the second switch lever SWL2, the second switch SW2 can be turned on/off.

A mechanical motion limitation device may comprise a detection part DP to promote interaction with a sensor device. For example, a mechanical motion limitation device may comprise at least one of a coating, surface, structure etc. adapted in view of a respective sensor device. For example, a mechanical motion limitation device may have a coating and/or surface adapted for detection by an encoder, inductive sensor, capacitive sensor, optical sensor, Hall-effect sensor, magnetic sensor.

According to the drawing, the first mechanical motion limitation device FMMLD comprises a detection part DP in form a structure adapted for interaction with the first switch lever SWL1 and the second switch SW2 lever SWL2. As illustrated, the first mechanical motion limitation device FMMLD has an extension EXT, according to the drawing, extending from the end-stop ES downwards. At the free end of the extension EXT, it comprises a contact structure CST.

FIG. 8 illustrates an operational state where the first sensor device SD1 detects the first mechanical motion limitation device FMMLD being in a release position. In the release position, the contact structure CST of the first mechanical motion limitation device FMMLD contacts the first switch lever SWL1 and, as a result, turns the first switch SW1 on (or off). The fact that the first switch SW1 is turned on (or turned off) indicates that the first mechanical motion limitation device FMMLD is in a release position.

In the case a motion range between the first linkage member and second linkage member SLM is to be limited, the first mechanical motion limitation device FMMLD is brought into a lock position. Due this process, the contact structure CST is moved out of the contact with the first switch lever SWL1. This turns the first switch SW1 off (or on). The fact that the first switch SW1 is turned off (or turned on) indicates that the first mechanical motion limitation device

FMMLD is not in a release position. In the lock position, the contact structure of the first mechanical motion limitation device FMMLD contacts the second switch lever SWL2 and, as a result, turns the second switch SW2 on (or off). The fact that the second switch SW2 is turned on (or turned off) indicates that the first mechanical motion limitation device FMMLD is in a lock position.

During the transition of the first mechanical motion limitation device FMMLD from the release position to the lock position, none of the first switch SW1 and the second switch SW2 is turned on (or off). This indicates that the first mechanical motion limitation device FMMLD is neither in the release position no in the lock position. This may be taken as indication that the first mechanical motion limitation device FMMLD is in an intermediate position between the release position and the lock position

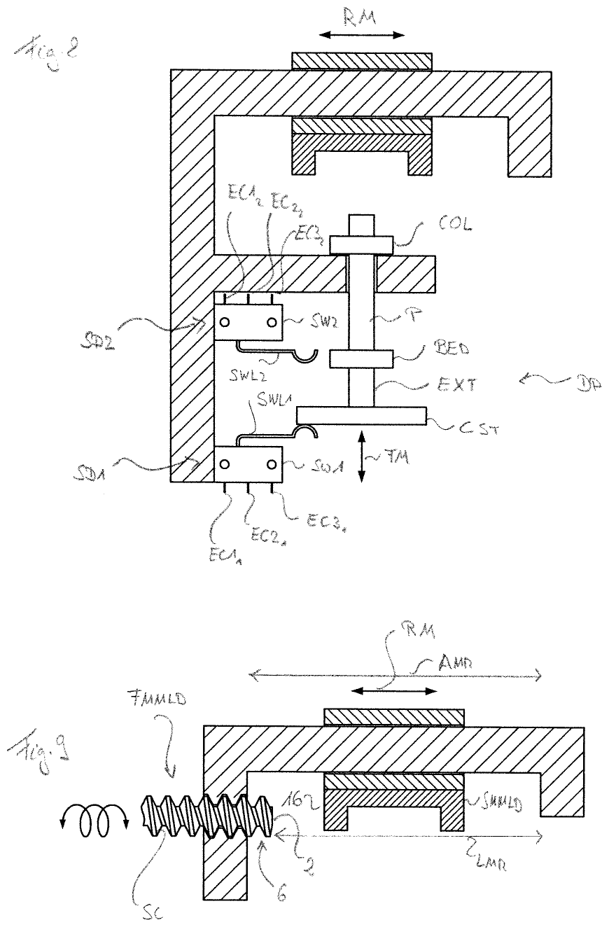

FIG. 9 illustrates an example of a first mechanical motion limitation device FMMLD comprising a screw SC having an engagement portion 6 with a contact area 2. The screw extends through a threaded aperture TA of the first linkage member FLM.

A second mechanical motion limitation device SMMLD may be comparable to the second mechanical motion limitation device SMMLD of, e.g., FIGS. 1A-F and comprises a contact area 16 arranged at a part of the second mechanical motion limitation device SMMLD that may, depending on position/movement of the second mechanical motion limitation device SMMLD and/or the first mechanical motion limitation device FMMLD, engage with the contact area 2 of the first mechanical motion limitation device FMMLD.

By rotating the screw SC with respect to the threaded aperture TA, the position of the contact area 2 of the first mechanical motion limitation device FMMLD in relation to the contact area 16 of the second mechanical motion limitation device SMMLD may be varied and set in order to define a limited motion range LMR. As long as the contact area 2 of the first mechanical motion limitation device FMMLD and the contact area 16 of the second mechanical motion limitation device SMMLD are not engaging with each other, the first linkage member FLM and the second linkage member SLM can be moved in relation to each other. Such relative movement is limited upon engagement of the contact area 2 of the first mechanical motion limitation device FMMLD and the contact area 16 of the second mechanical motion limitation device SMMLD.

It is noted that the example of FIG. 9 may also include a further first mechanical motion limitation device FMMLD. For example, the first mechanical motion limitation device FMMLD of FIGS. 1A-F may be provided additionally. In such examples, the first mechanical motion limitation device FMMLD with the screw SC may be used to define, between first linkage member FLM and the second linkage member SLM, a limited motion range LMR that is maintained during, e.g., an operational use phase (e.g., like a pre-setting); while a first mechanical motion limitation device FMMLD of FIGS. 1A-F may be used to define, between the first linkage member FLM and the second linkage member SLM, a limited motion range that may be selectively modified, e.g. during operation.

FIG. 10 illustrates an example having a first mechanical motion limitation device FMMLD1 and a second first mechanical motion limitation device FMMLD2. Each of these mechanical motion limitation devices has an engagement portion 6 with at least one contact area providing progressive motion limitation characteristics.

The engagement portion 6₁ of the first mechanical motion limitation device FMMLD1 has a contact area 2₁. The contact area 2₁ has a surface inclined with respect to the axis (see arrow FM1 below first mechanical motion limitation device FMMLD1) along which the first mechanical motion limitation device FMMLD1 may be moved. Due to the shape of the contact area 2₁, the first mechanical motion limitation device FMMLD1 may assume one or more lock positions. For example, the first mechanical motion limitation device FMMLD1 may be positioned in a first lock position such that, in the case the second linkage member SLM is moved, according to the drawing, to the right, a contact area 14 and a portion 2₁′ of the contact area 2₁ contact each other. For example, the first mechanical motion limitation device FMMLD1 may be positioned in a second lock position such that, in the case the second linkage member SLM is moved, according to the drawing, to the right, the contact area 14 and a portion 2₁″ of the contact area 2₁ contact each other. The latter second lock position of the first mechanical motion limitation device FMMLD1 enables a larger motion range LMR2 between the first linkage member FLM and the second linkage member SLM as compared to the motion range LMR1 between the first linkage member FLM and the second linkage member SLM that is enabled when the first mechanical motion limitation device FMMLD1 is positioned in the former first lock position. Depending on the granularity of movement possible for the first mechanical motion limitation device FMMLD1, one, two, up to a virtual infinite number of lock positions in between may be possible.

The engagement portion 6₂ of the second first mechanical motion limitation device FMMLD2 has a contact area 2₂. The contact area 2₂ has a surface inclined with respect to the axis (see arrow FM2 below second first mechanical motion limitation device FMMLD2) along which the second first mechanical motion limitation device FMMLD2 may be moved. Due to the shape of the contact area 2₂, the second first mechanical motion limitation device FMMLD2 may assume one or more lock positions. For example, the second first mechanical motion limitation device FMMLD2 may be positioned in a first lock position such that the contact area 2₂ lies in a first plane CP1. In the case the second linkage member SLM is moved, according to the drawing, to the left, a contact area 16 and a portion 2₂′ of the contact area 2₂ contact each other at/in place CP1. For example, the second first mechanical motion limitation device FMMLD2 may be positioned in a second lock position such that contact area 2₂ lies in a second plane CP2. In the case the second linkage member SLM is moved, according to the drawing, to the left, the contact area 16 and a portion 2₂″ of the contact area 2₂ contact each other at/in place CP2. The latter second lock position of the second first mechanical motion limitation device FMMLD2 enables a larger motion range LMR4 between the first linkage member FLM and the second linkage member SLM as compared to the motion range LMR3 between the first linkage member FLM and the second linkage member SLM that is enabled when the first mechanical motion limitation device FMMLD1 is positioned in the former first lock position. Depending on the granularity of movement possible for the second first mechanical motion limitation device FMMLD2, one, two, up to a virtual infinite number of lock positions in between may be possible.

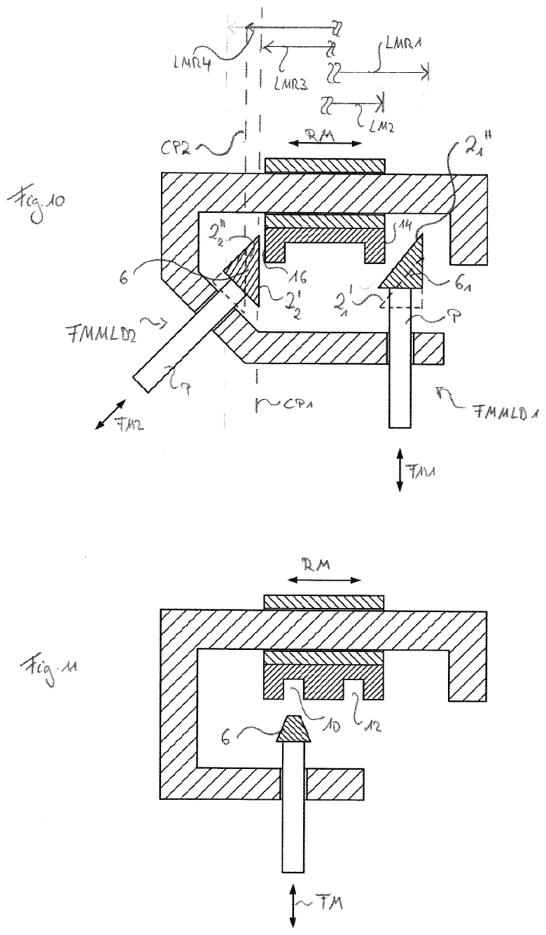

FIG. 11 illustrates an example where a first mechanical motion limitation device FMMLD and a second mechanical motion limitation device SMMLD are shaped such that at least one parked/blocked position of the first linkage member FLM and second linkage member SLM in relation to each other may be achieved.

According to FIG. 11, the second mechanical motion limitation device SMMLD has a contact area 10 formed as recess. In the case, an engagement portion 6 of the first mechanical motion limitation device FMMLD and the contact area 10 contact each other, virtually all of the motion range between the first linkage member FLM and the second linkage member SLM is removed.

The second mechanical motion limitation device SMMLD may have a further contact area 12 formed as recess. In the case, an engagement portion 6 of the first mechanical motion limitation device FMMLD and the contact area 12 contact each other, virtually all of the motion range between the first linkage member FLM and the second linkage member SLM is removed.

According to FIG. 11, two distinct parked/blocked positions are provided. In other examples, the second mechanical motion limitation device SMMLD comprise one or more further contact areas comparable to contact area 10 and/or 12. Such examples provide at least three parked/blocked positions.

In order to limit the influence of play of the engagement between the engagement portion 6 and the contact area 10 and/or 12, the engagement portion 6 may have a wedged shape as illustrated in FIG. 11. In other examples, the engagement portion 6 may shaped as illustrated in, e.g., FIGS. 1A-F.

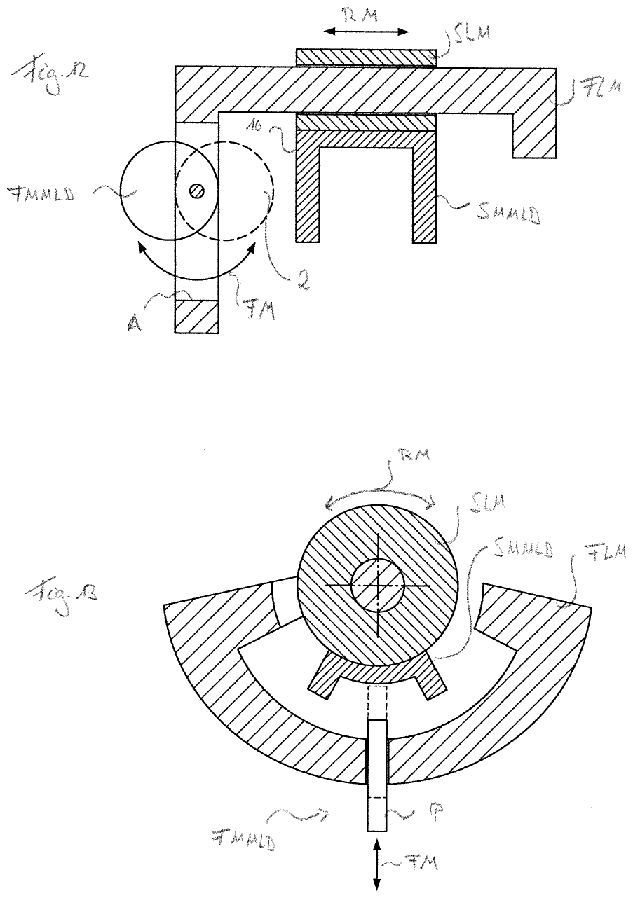

FIG. 12 illustrates an example having a rotatable first mechanical motion limitation device FMMLD. The example of FIG. 12 includes an option to operate the first mechanical motion limitation device FMMLD to provide progressive motion limitation characteristics.

FIG. 12 illustrates the first mechanical motion limitation device FMMLD in a release position (see solid lines). The first mechanical motion limitation device FMMLD may be rotated as indicated by the arrow. In some examples, the first mechanical motion limitation device FMMLD may be positioned in a lock position indicated by the dashed lines. In such examples, the first mechanical motion limitation device FMMLD has a single lock position. In the lock position, a contact of a contact area 2 of the first mechanical motion limitation device FMMLD and a contact area 16 of the second mechanical motion limitation device SMMLD limit a motion range RM between the first linkage member FLM and the second linkage member SLM.

In further examples, the first mechanical motion limitation device FMMLD may provide at least two up to virtually infinite numbers of lock positions. In such examples, the first mechanical motion limitation device FMMLD may be positioned such that at least some part of the first mechanical motion limitation device FMMLD extends through an aperture A in the first linkage member FLM towards the second mechanical motion limitation device SMMLD.

Then, the part protruding towards the second mechanical motion limitation device SMMLD provides a contact area, wherein a contact between that contact area and the contact area 16 of the second mechanical motion limitation device SMMLD limit a motion range between the first linkage member FLM and the second linkage member SLM. Depending on the granularity of movement possible for the first mechanical motion limitation device FMMLD, one, two, up to a virtual infinite number of lock positions in between may be possible.

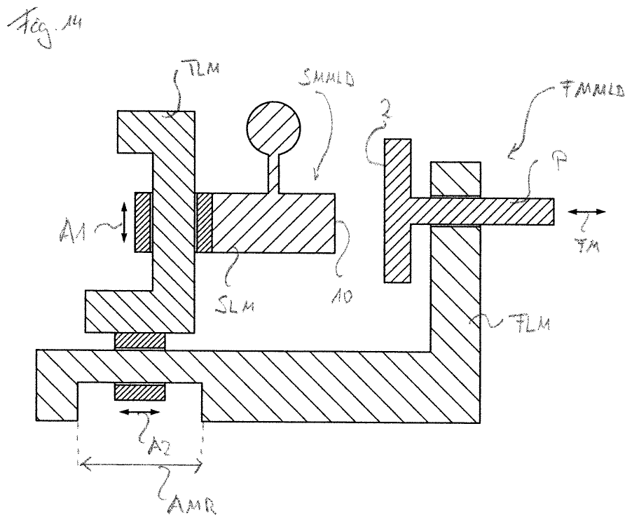

FIG. 13 illustrates an example, where the first linkage member FLM and the second linkage member SLM may be (at least) rotated with respect to each other, as indicated be the arrow RM. Any of the above observations where the first linkage member FLM and the second linkage member SLM may be (at least) translated with respect to each other apply here correspondingly.

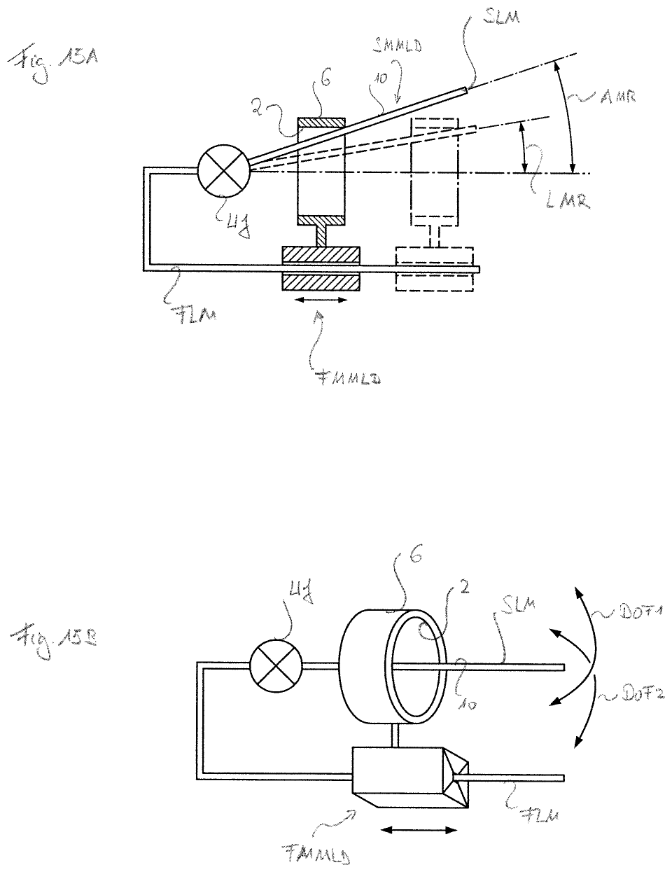

FIG. 14 illustrates an example where the first linkage member FLM and the second linkage member SLM are not adjacent linkage members of a kinematic chain. As illustrated, between the first linkage member FLM and the second linkage member SLM, a third linkage member TLM is arranged. The second linkage member SLM may be moved, as indicated by arrow A1, in relation to the third linkage member TLM. The third linkage member TLM may be moved, as indicated by arrow A2, in relation to the first linkage member FLM. The available motion range between the third linkage member TLM and the first linkage member FLM is indicated at AMR. If the third linkage member TLM and the first linkage member FLM are moved in relation to each other along the directions indicated by arrow A2, the second linkage member SLM moved together with the third linkage member TLM. The available motion range between the first linkage member FLM and second linkage member SLM along directions indicated by arrow A2 is indicated at AMR.

A first mechanical motion limitation device FMMLD coupled to the first linkage member FLM is provided. The first linkage member FLM has a contact area 2.

According to FIG. 14, the second linkage member SLM comprises a portion acting as second mechanical motion limitation device SMMLD. The second mechanical motion limitation device SMMLD has a contact area 10.

FIG. 14 illustrates the first mechanical motion limitation device FMMLD in a release position, in which no engagement of the first mechanical motion limitation device FMMLD and the second mechanical motion limitation device SMMLD is possible and, thus, a motion range between the first linkage member FLM and the second linkage member SLM is not affected.

If the first mechanical motion limitation device FMMLD is moved, according to the drawing, to the left, the first mechanical motion limitation device FMMLD may be positioned in a lock position in which engagement of the first mechanical motion limitation device FMMLD and the second mechanical motion limitation device SMMLD is possible and, thus, the motion range between the first linkage member FLM and the second linkage member SLM may be limited. Depending on the granularity of movement possible for the first mechanical motion limitation device FMMLD, one, two, up to a virtual infinite number of lock positions in between may be possible.

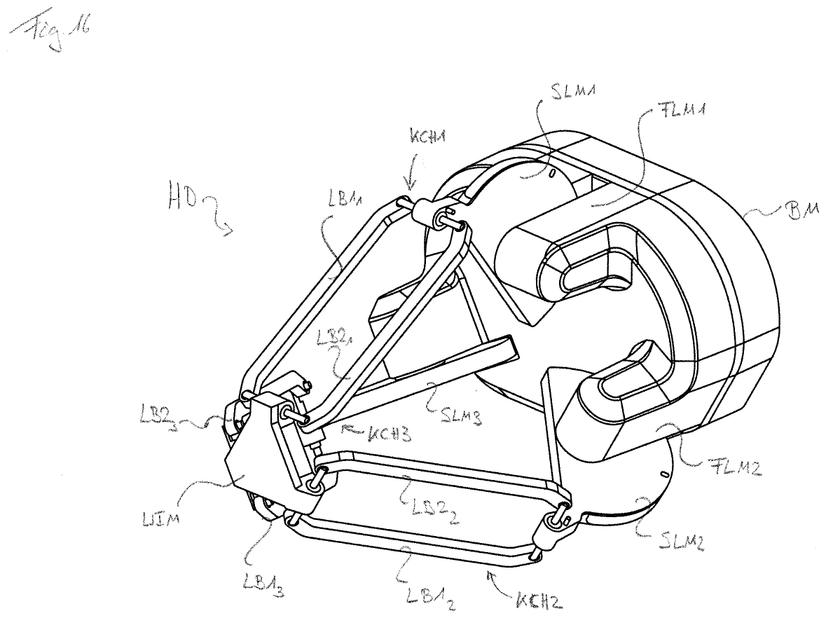

FIGS. 15A-B illustrate an example where a first linkage member FLM and second linkage member SLM are coupled via a universal joint UJ. The universal joint UJ allows such relative movement in two degrees of freedom as indicate by arrows DOF1 and DOF2

A first mechanical motion limitation device FMMLD is provided movably in relation to the first linkage member FLM. The first mechanical motion limitation device FMMLD comprises an engagement portion 6 formed a ring. The inner surface of the ring provides a contact area 2 of the first mechanical motion limitation device FMMLD.

In the left-hand side position of the first mechanical motion limitation device FMMLD (solid lines), the first mechanical motion limitation device FMMLD is in a release position. In above examples, an available motion range was defined, e.g., by the shape, coupling etc. of at least one of the first linkage member FLM and the second linkage member SLM, etc. Here, the first mechanical motion limitation device FMMLD in a release position defines, at least partially, an available motion range AMR between the first linkage member FLM and the second linkage member SLM. The closer the first mechanical motion limitation device FMMLD is positioned towards the universal joint, the larger the available motion range is. The available motion range can be even larger in the case the first mechanical motion limitation device FMMLD is beyond the universal joint, i.e., according to the drawing positions left of the universal joint.

According to the drawing, the second linkage member SLM also acts as second mechanical motion limitation device SMMLD. More particularly, the surface of the second linkage member SLM act as contact area 10 of a second mechanical motion limitation device SMMLD.

In the release position, the available motion range AMR is the range of movements in at least one of the two degrees of freedom DOF1 and DOF1 between the first linkage member FLM and the second linkage member SLM, as long as the contact area 2 and the contact area 10 are not engaging with each other.

The dashed illustration of the first mechanical motion limitation device FMMLD at the right illustrates the first mechanical motion limitation device FMMLD in a lock position. In the lock position, the motion range between the first linkage member FLM and the second linkage member SLM is limited as indicated at LMR. Depending on the granularity of movement possible for the first mechanical motion limitation device FMMLD, one, two, up to a virtual infinite number of lock positions in between may be possible. According to FIGS. 15A-B, any position of the first mechanical motion limitation device FMMLD right of a release position may be a lock position.

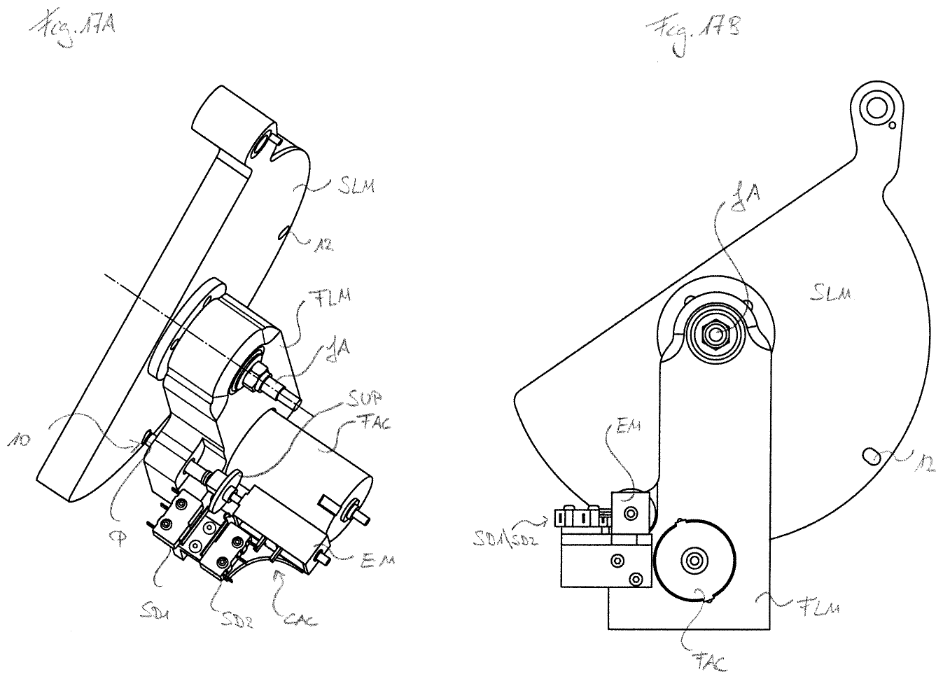

FIG. 16 illustrates a haptic device HD comprising a user interface member UIM that is coupled to a base member BM via three kinematics chains KCH1, KCH2, KCH3. Each kinematics chain KCH comprises linkage bars as well as a rotatable linkage member, namely kinematics chain KCH1 comprises a linkage bars LB1₁ and LB2₁ and a rotatable linkage member SLM1; kinematics chain KCH2 comprises a linkage bars LB1₂ and LB2₂ and a rotatable linkage member SLM2; kinematics chain KCH3 comprises a linkage bars LB1₃ and LB2₃ and a rotatable linkage member SLM3.

Linkage member SLM1 and a linkage member FLM1 of the base member are coupled such that linkage member SLM1 and linkage member FLM1 may be rotated in relation to each other.

Linkage member SLM2 and a linkage member FLM2 of the base member are coupled such that linkage member SLM2 and linkage member FLM2 may be rotated in relation to each other.

Linkage member SLM3 and a linkage member FLM3 of the base member are coupled such that linkage member SLM3 and linkage member FLM3 may be rotated in relation to each other.

In the following, reference is made to only one of the kinematics chains, e.g., kinematics chain KCH1. However, observations in relation to kinematics chain KCH1 apply also to the other kinematics chains KCH2 and/or KCH3.

The linkage member FLM1 may be considered as first linkage member in the sense of the present disclosure. The linkage member SLM1 may be considered as second linkage member in the sense of the present disclosure.

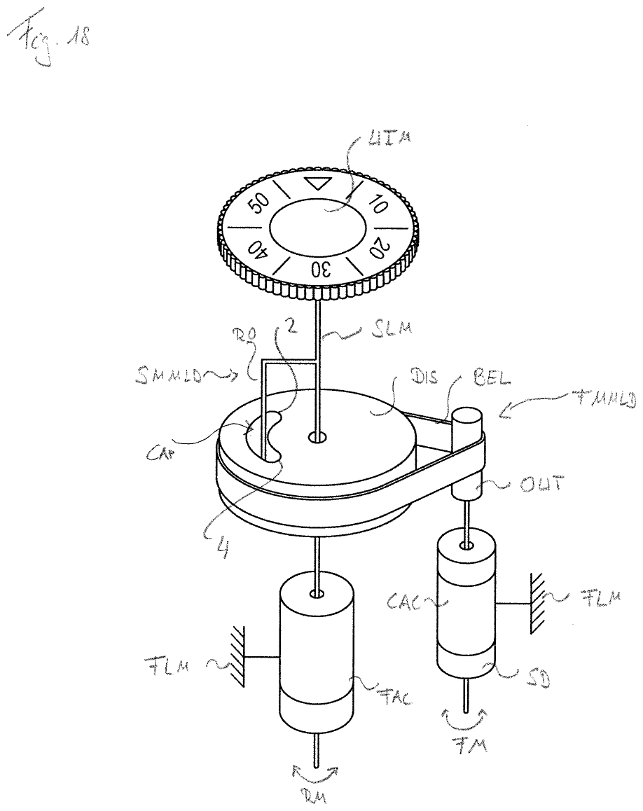

As illustrated in FIGS. 17A-B, the first linkage member FLM and the second linkage member SLM are rotatably coupled via a joint axis JA.

The first linkage member FLM comprises a first mechanical motion limitation device FMMLD. The first mechanical motion limitation device FMMLD comprises a pin P. The pin P may be in operative engagement with a spring. The spring may be a spring SED of an energy storing-releasing device, for example, as illustrated in FIG. 4. For actuating the pin P, the first mechanical motion limitation device FMMLD may comprise an actuator, for example, an (e.g., bi-stable) electro-magnet EM. The output end of the actuator EM is coupled with a support SUP at the pin P. This arrangement allows a spring-loaded coupling of the actuator EM and the pin P.

One or more sensor devices SD1, SD2 for sensing positions and/or movement of the pin P are provided.

The second linkage member SLM comprises at least one portion acting as second mechanical motion limitation device SMMLD. According to the drawing, the second mechanical motion limitation device SMMLD comprises a portion including an aperture acting as a contact area 10 of a second mechanical motion limitation device SMMLD.

If the first mechanical motion limitation device FMMLD exhibits a release position, i.e., the pin P and the contact area 10 are not engaging with each other, the available motion range between the first linkage member FLM and the second linkage member SLM may be used.

If the first mechanical motion limitation device FMMLD exhibits a lock position, i.e., the pin P and the contact area 10 are engaging with each other, the motion range between the first linkage member FLM and the second linkage member SLM is limited. Due to the contact area 10 being provided as aperture, engagement of the pin P and the contact areas effects that essentially no relative movement between the first linkage member FLM and the second linkage member SLM is possible.

The second linkage member SLM may provide a further contact area 12 of the second mechanical motion limitation device SMMLD.

If the first mechanical motion limitation device FMMLD exhibits a release position, i.e., the pin P and the contact area 12 are not engaging with each other, the available motion range between the first linkage member FLM and the second linkage member SLM may be used.

If the first mechanical motion limitation device FMMLD exhibits a lock position, i.e., the pin P and the contact area 12 are engaging with each other, the motion range between the first linkage member FLM and the second linkage member SLM is limited. Due to the contact area 12 being provided as aperture, engagement of the pin P and the contact areas effects that essentially no relative movement between the first linkage member FLM and the second linkage member SLM is possible.

The difference between the lock position related with the contact area 10 and the lock position related with the contact area 12 is that the positions in which the second linkage member SLM is parked/blocked differ.

The example of FIGS. 17A-B also comprises an actuator FAC for providing haptic feedback via the second linkage member SLM and the related linkage bars LB to the user interface member UIM.

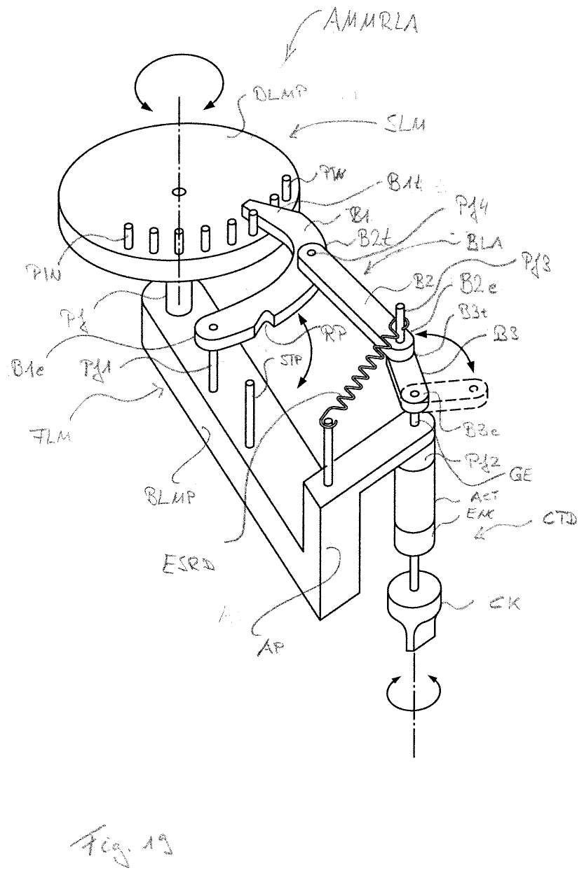

FIG. 18 schematically illustrates a further example of an adjustable mechanical motion range limitation apparatus, e.g., for a haptic interaction simulation device. For example, the example of FIG. 18 may be used in a haptic device in form of a watch interaction simulator.

The example of FIG. 18 comprises a first linkage member FLM being a base of the haptic device and a second linkage member SLM being rotatable in relation to the first linkage member FLM and the base, respectively. The second linkage member SLM comprises a rod RO being arranged between a user interface member UIM in form of a dial and an actuator FAC for providing haptic feedback at the user interface member UIM. To the first linkage member FLM, a first mechanical motion limitation device FMMLD is coupled.

The first mechanical motion limitation device FMMLD comprises controllable actuator CAC and at least one sensor device SD. Any of the above observations with respect controllable actuators and sensor correspondingly apply here.

The first mechanical motion limitation device FMMLD comprises a belt-driven mechanism having a belt BEL coupled between an output OUT of the controllable actuator CAC and a rotatable disc DIS. The rotatable disc DIS comprises a curved aperture CAP. The curved aperture CAP comprises a first contact area 2 and a second contact area 4.

A second mechanical motion limitation device SMMLD is coupled to the second linkage member SLM. The second mechanical motion limitation device SMMLD comprises a rod RO extending through curved aperture CAP.

FIG. 18 illustrates a situation where the user interface member UIM can be rotated in clock-wise and anti-clock-wise directions as long as the rod RO does not contact one of the contact area 2 and the contact area 4. This situation represents a lock position for the first mechanical motion limitation device FMMLD, because the rotation of the second linkage member SLM and, thus, the rotation of the user interface member UIM is limited by the size of the curved aperture CAP.

By rotating the disc DIS, the position of the curved aperture CAP and, thus, the location of the motion range between the first linkage member FLM and the second linkage member SLM can be varied. FIG. 18 illustrates a location of that motion range at about “9 o'clock”. Depending on the rotation of the disc DIS, location of that motion range, e.g., at about “noon”, “3 o'clock”, “5 o'clock”, and the like can be provided. In any of such cases, the first mechanical motion limitation device has a lock position.

The maximal available motion range between the first linkage member FLM and the second linkage member SLM may be extended by rotating the disc DIS such that the curved aperture CAP moves in the same direction and with approximately the same speed as the rod RO (i.e., as the second linkage member SLM and the user interface member UIM). This avoids contact of the rod RO and one of the contact areas 2 and 4, and the second linkage member and, thus, the user interface member UIM may be rotated in at least one direction without limitation.

FIG. 19 schematically illustrates a further example of an adjustable mechanical motion range limitation apparatus, e.g., for a haptic interaction device. For example, the example of FIG. 19 may be used in a haptic device wrist mechanism.

FIG. 19 illustrates an adjustable mechanical motion range limitation apparatus AMMRLA comprising a first linkage member FLM and a second linkage member SLM, both being movable in relation to each other. According to the illustration, the first linkage member FLM and the second linkage member SLM can be rotated in relation to each other. According to the illustration, the first linkage member FLM has a bar-like main portion BLMP and, extending therefrom, an angled portion AP.

According to the illustration, the second linkage member SLM has disc-like main portion DLMP. The disc-like main portion DLMP of the second linkage member SLM and the bar-like main portion BLMP of the first linkage member FLM are coupled via a pivot joint PJ. A first mechanical motion limitation device FMMLD is coupled to the first linkage member FLM and comprises a bar linkage arrangement BLA.

A second mechanical motion limitation device SMMLD is coupled to the second linkage member SLM and comprises several pins PIN extending from the disc-like main portion DLMP.

The bar linkage arrangement BLA comprises a first bar B1 having an end B1e being rotatably in relation to the first linkage member FLM. This is achieved according to the illustration by the end B1e and the bar-like main portion BLMP of the first linkage member FLM being coupled via a pivot joint PJ1. The other free end or tip B1t of the first bar FB1 is adapted or designed for engagement with one or more of the pins PIN of the second mechanical motion limitation device SMMLD, as explained further below. For limitation of rotations of the first bar B1 in the (according to the illustration) clock-wise direction, an end stop may be provided. According to the illustration, this may include a stop pin STP extending from the first linkage member FLM, wherein the first bar B1 may include a receiving portion RP with which the stop pin STP may engage.

The bar linkage arrangement BLA comprises a second bar B2 being arranged between the first bar B1 and a third bar B3 of the bar linkage arrangement BLA.

The third bar B3 is rotatably in relation to the first linkage member FLM. This is achieved according to the illustration by an end B3e and the angled portion AP of the first linkage member FLM being coupled via a pivot joint PJ2.

An end B2e of the second bar B2 and an end B3t of the third bar B3 are rotatably coupled, according to the illustration via a pivot joint PJ3, so that the second bar B2 and the third bar B3 can be rotated with respect to each other. Further, an end B2t of the second bar B2 and a mid portion of the first bar B1 are rotatably coupled, according to the illustration via a pivot joint PJ4, so that the second bar B2 and the first bar B1 can be rotated with respect to each other.

The bar linkage arrangement BLA comprises, as an optional energy storing-releasing device ESRD, in this example a spring coupled between the angled portion AP of the first linkage member FLM and the pivot joint PJ3 or, alternatively, between the angled portion AP of the first linkage member FLM and any portion of the third bar B3.

The bar linkage arrangement BLA can be operated in bi-stable manner.

In the situation illustrated in FIG. 19 by solid lines, the bar linkage arrangement BLA has a lock position in which the tip B1t of its first bar B1 and a pin of the second linkage member SLM can engage with each other. In other words, in the lock position of the bar linkage arrangement BLA it can be said that the first bar B1 is introduced into interaction with the second linkage member SLM. As a result, in the lock position of the bar linkage arrangement BLA, a motion range between the first linkage member FLM and the second linkage member SLM is limited. The lock position of the bar linkage arrangement BLA is maintained by the spring ESRD, which biases the bar linkage arrangement BLA into this position.

In the situation illustrated in FIG. 19 by dashed lines, the bar linkage arrangement BLA has a release position in which the tip B1t of its first bar B1 and a pin of the second linkage member SLM cannot engage with each other. In other words, in the release position of the bar linkage arrangement BLA it can be said that the first bar B1 is retracted from interaction with the second linkage member SLM. As a result, in the release position of the bar linkage arrangement BLA a motion range between the first linkage member FLM and the second linkage member SLM is not limited. The release position of the bar linkage arrangement BLA is maintained by the spring ESRD, which biases the bar linkage arrangement BLA into the release position.

Transitions between the lock position and release position of the bar linkage arrangement BLA, and vice versa, can be effected by a control device CTD. According to the illustration, the control device CTD is coupled to the third bar B3 of the bar linkage arrangement BLA via the pivot joint PJ2 in such a manner that a rotation of the control device CTD results in a rotation of the third bar B3 about the axis of the pivot joint PJ2. By rotation of the control CTD, the third bar B3 can be moved between its position illustrated by solid lines (i.e., position for the lock position of the bar linkage arrangement BLA) and its position illustrated by dashed lines (i.e., position for the lock position of the bar linkage arrangement BLA).

The control device CTD may include a control member or knob CK for manual interaction by a user. The control device CTD may comprise, e.g. arranged between the control member/knob CK and the third bar B3, at least one of an encoder ENC, an actuator ACT and a gear arrangement GE.

The encode ENC may be provided to determine and/or control rotational positions of the control device CTD. The actuator ACT may be provided to support rotations induced by manual user interaction via the control member/knob CK. The gear arrangement GE may be provided for increase or reduction of rotations induced by manual user interaction via the control member/knob CK and/or the actuator ACT.

In the case, the bar linkage arrangement BLA is in its lock position, the motion range between the first linkage member FLM and the second linkage member SLM is limited. This limitation may be controlled by the spacing between neighboring pins PIN. For example, if two neighboring pins PIN have such a spacing that, if the tip B1t of the first bar B1 of the bar linkage arrangement BLA in its lock position is positioned between the two neighboring pins, the tip B1t is in contact with both neighboring pins PIN. Then, no motion of the first linkage member FLM and the second linkage member SLM in relation to each other is possible.

If two neighboring pins PIN have a larger spacing such that, if the tip B1t of the first bar B1 of the bar linkage arrangement BLA in its lock position is positioned between the two neighboring pins, the tip B1t has some freedom to move between the neighboring pins PIN before contacting one thereof, then motion range between the first linkage member FLM and the second linkage member SLM is limited accordingly.

If three or more pins PIN are used, the motion range limitation may be effected for different rotational positions of the first linkage member FLM and the second linkage member SLM in relation to each other. For example, if the tip B1t in the lock position of the bar linkage arrangement BLA is positioned between the two neighboring pins PIN at the, according to the illustration, right-hand side of the rows of pins, then the rotational position of the first linkage member and the second linkage member SLM in relation to each other differs from the rotational position in relation to each other for a case where the tip B1t in the lock position of the bar linkage arrangement BLA is positioned between the two neighboring pins PIN at the, according to the illustration, left-hand side of the rows of pins.

What is claimed is:

1. Adjustable-An adjustable mechanical motion range limitation apparatus for mechanically limiting relative motion between a pair of linkage members of a haptic device, wherein the haptic device includes
an active feedback device for providing active force and/or torque feedback towards a user of the haptic device,
a moveable user interface member,
wherein the pair of linkage members comprises a first linkage member and a second linkage member being movable in relation to each other,
wherein a motion range of the pair of linkage members controls a motion range of the moveable user interface member, the adjustable mechanical motion range limitation apparatus comprising
a first mechanical motion limitation device being moveable, independently from the active feedback device, in relation to the first linkage member, and
a second mechanical motion limitation device being coupled to the second linkage member,
wherein
the first mechanical motion limitation device (FMMLD) has, in relation to the first linkage member (FLM), a release position in which the first mechanical motion limitation device (FMMLD) and the second mechanical motion limitation device (SMMLD) cannot engage, so that a predefined available motion range (AMR) between the first linkage member (FLM) and the second linkage member (SLM) is not limited, and
the first mechanical motion limitation device (FMMLD) has, in relation to the first linkage member (FLM), a lock position in which the first mechanical motion limitation device (FMMLD) mechanically engages with the with the second mechanical motion limitation device (SMMLD), thereby at least limiting a motion range between the first linkage member (FLM) and the second linkage member (SLM) so that the available motion range between the first linkage member (FLM) and the second linkage member (SLM) is limited to a defined limited motion range (LMR).

2. The adjustable mechanical motion range limitation apparatus according to claim 1, wherein the second mechanical motion limitation device
is provided at a fixed location with respect to the second linkage member, or
is movable with respect to the second linkage member.

3. (Canceled)

4. The adjustable mechanical motion range limitation apparatus of claim 1, comprising a passive energy storing-releasing device being configured to provide force and/or torque to the first mechanical motion limitation device.

5. (Canceled)

6. The adjustable mechanical motion range limitation apparatus according to claim 1, wherein a controllable active actuator is associated to at least one of the first linkage member and the second linkage member, the controllable active actuator to provide force and/or torque to the first mechanical motion limitation device.

7. (Canceled)

8. The adjustable mechanical motion range limitation apparatus according claim 1, further comprising an actuator controller being configured to control the position and/or the movement and/or the velocity and/or the acceleration and/or the force and/or the torque of the controllable active actuator.

9. The adjustable mechanical motion range limitation apparatus according to claim 1, wherein the actuator controller is configured to control the position and/or the movement and/or the velocity and/or the acceleration and/or the force and/or the torque of the actuator in dependence of a relative position and/or movement and/or velocity and/or force and/or torque between the first linkage member and second linkage member.

10. (Canceled)

11. (Canceled)

12. (Canceled)

13. The adjustable mechanical motion range limitation apparatus according to claim 1, further comprising a control member being configured to manually, by a user, to at least one of
position the first mechanical motion limitation device,
move the first mechanical motion limitation device,
apply a force on the first mechanical motion limitation device,
apply a torque on the first mechanical motion limitation device.

14. (Canceled)

15. The adjustable mechanical motion range limitation apparatus according to claim 1, further comprising a damping device coupled to at least one of the first mechanical motion limitation device and the second mechanical motion limitation device, wherein the damping device is configured to damp at least one of a force and/or a torque acting on at least one of the first mechanical motion limitation device and the second mechanical motion limitation device upon engagement of the first mechanical motion limitation device and the second mechanical motion limitation device.

16. (Canceled)

17. The adjustable mechanical motion range limitation apparatus according to claim 1, further comprising a transmission mechanism being coupled with the first mechanical motion limitation device.

18. The adjustable mechanical motion range limitation apparatus according to claim 1, further comprising:
a transmission mechanism being coupled with the first mechanical motion limitation device; and
a passive energy storing-releasing device being configured to provide force and/or torque to the first mechanical motion limitation device;
wherein a controllable active actuator is associated to at least one of the first linkage member and the second linkage member, the controllable active actuator to provide force and/or torque to the first mechanical motion limitation device; and
wherein the transmission mechanism is being configured to couple the first mechanical motion limitation device and at least one of the passive energy storing-releasing device, the controllable active actuator and the control member.

19. (Canceled)

20. (Canceled)

21. (Canceled)

22. The adjustable mechanical motion range limitation apparatus according to claim 1, comprising at least one of:
at least one further first mechanical motion limitation device, and
at least one further second mechanical motion limitation device.

23. The adjustable mechanical motion range limitation apparatus according to claim 1, being adapted to limit the motion range between the first linkage member and the second linkage member in such a manner that the relative motion between the first linkage member and the second linkage member is constrained and/or locked in place when the first mechanical motion limitation devices and the second mechanical motion limitation device engage.

24. A haptic device comprising
a pair of linkage members,
an active feedback device for providing active force and/or torque feedback towards a user of the haptic device,
a moveable user interface member, wherein
the pair of linkage members comprises a first linkage member and a second linkage member being movable in relation to each other,
a motion range of the pair of linkage members controls a motion range of the moveable user interface member,
the haptic device further comprising at least one adjustable mechanical motion range limitation apparatus.

25. (Canceled)

26. (Canceled)

27. The haptic device according to claim 24, wherein at least one of the at least one adjustable mechanical motion range limitation apparatus according to one of the claims 1 to 21 is adapted to constrain and/or lock at least one translational motion and/or at least one rotational motion of the moveable user interface member.

28. The haptic device according to claim 24, wherein the haptic device comprises a watch interaction simulator or is part of a watch interaction simulator.
